(19) United States
(12) Patent Application Publication
(10) Pub. No.: US 2014/0149749 A1
(43) Pub. Date: May 29, 2014

(54) METHOD AND DEVICE FOR PREVENTING LOGGING OF COMPUTER ON-SCREEN KEYBOARD

(71) Applicant: Chi-Pei WANG, Hsinchu City (TW)

(72) Inventor: Chi-Pei WANG, Hsinchu City (TW)

(21) Appl. No.: 14/078,944

(22) Filed: Nov. 13, 2013

(30) Foreign Application Priority Data
Nov. 29, 2012 (TW) 101144630

(51) Int. Cl. G06F 21/83

(52) U.S. Cl. CPC G06F 21/83
USPC 713/189

(57) ABSTRACT

A method and device for preventing logging of a computer on-screen keyboard includes an application software set into the computer, allowing to input words via on-screen keyboard. A pointer device has an encryption module. The application software is used to obtain push-button or coordinate data of an encrypted pointer device via encryption module set into the pointer device. The application software is also used to obtain real push-button or coordinate data of the pointer device by means of decryption. With this design, the on-screen logging software cannot obtain real push-button or coordinate data of the pointer device by means of logging, so the on-screen logging cannot be activated or enabled for logging of on-screen keyboard.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a data protection technology for computer pointing devices (e.g. mouse, optical pen, touchpad and touch screen, etc.), and more particularly to an innovative method and device which are designed to prevent the input data of computer pointing devices from being obtained by on-screen logging software.

2. Description of Related Art Including Information Disclosed Under 37 CFR 1.97 and 37 CFR 1.98.

Computer products are utilized in such a manner that an on-screen keyboard is often used to input accounts and passwords in addition to data input via physical keyboard. Yet, existing on-screen logging software enables logging of the computer screen to obtain data input by on-screen keyboard, leading to leakage of important secrets of the users.

In view of prevailing computer-related encryption technologies and products, though anti-logging encryption products and file encryption software have been launched, the current encryption products cannot yet solve the aforementioned problem of logging against on-screen keyboard, so the users' important secrets are still exposed to possible leakage due to imperfect anti-logging functions. For example, the prior art is provided with a virtual keyboard activated during login the system server. Each of the key is composed of 16 images, which are presented by quick screening, allowing to watch every keyed word using the visual reaction with retentive power; and the keying positions will be updated upon clicking. So, only fragmentary images could be acquired by the logging procedure when capturing the screen by clicking the keys. However, since the keying positions are often changed, such on-screen anti-logging method makes it difficult and time-consuming for identification by the users. Moreover, such virtual keyboard system is applied in a limited range since it must be provided by the system operators. Furthermore, such on-screen anti-logging method may also be exposed to hackers by virtue of an improved on-screen logging means. Another CAPTCHA dynamic text code system allows the users to select the pass graph and the capturing rule for the lower dynamic words. Such anti-logging technology could avoid the attack from keyboard logging and asterisk password removal, but when the on-screen capturing procedures have taken multiple login pictures, the pass graphs and capturing rule could also be composed by the hackers.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

Based on the unique technical characteristics of the present invention wherein the pointer device or tandem device with encryption module is applied for decryption in conjunction with the application software, the clicking events of the pointer device are not presented on the computer screen, so on-screen logging software could not obtain the real clicking images by capturing computer screen images (note: the on-screen logging software triggers the logging by detecting the pointer device's clicking events), thus efficiently realizing anti-logging of input information via computer on-screen keyboard.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a text block diagram of the method of the present invention.

FIG. 2 is an application view of the present invention as a pointer device.

FIG. 3 is an application view of the present invention as a tandem device.

### DETAILED DESCRIPTION OF THE INVENTION

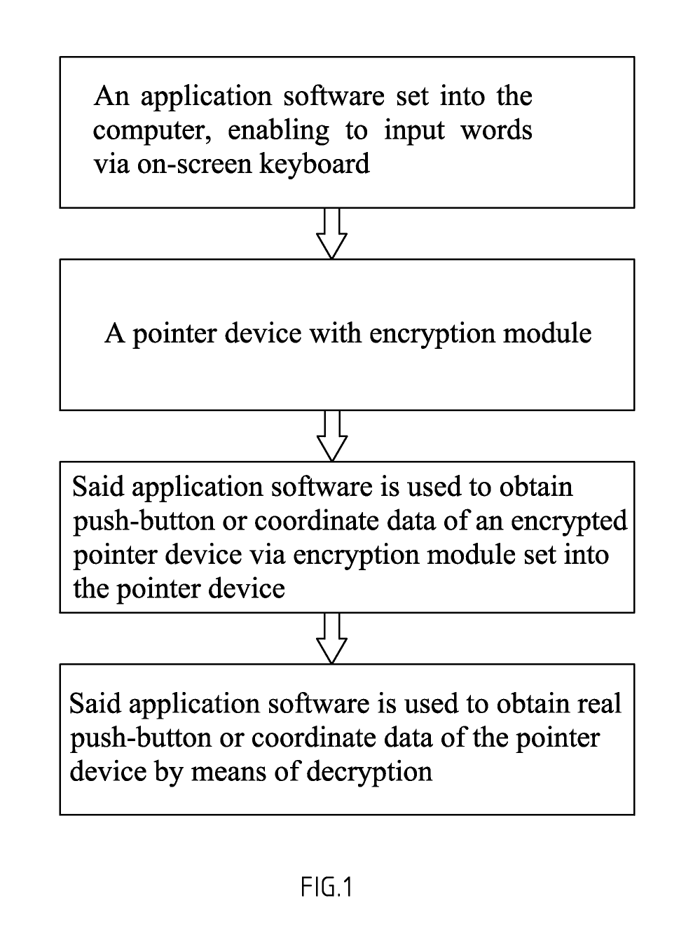

FIG. 1 depicts a preferred embodiment of a method and device of the present invention for preventing logging of a computer on-screen keyboard, which, however, is provided for only explanatory objective for patent claims.

Said computer on-screen keyboard anti-logging method comprises: an application software set into the computer, enabling to input words via on-screen keyboard; a pointer device with encryption module; said application software is used to obtain push-button or coordinate data of an encrypted pointer device via encryption module set into the pointer device; said application software is used to obtain real push-button or coordinate data of the pointer device by means of decryption. With this design, the on-screen logging software cannot obtain real push-button or coordinate data of the pointer device by means of logging, so the on-screen logging cannot be activated or enabled for logging of on-screen keyboard.

Of which, said pointer device comprises: mouse, optical pen, touchpad and touch screen. And said pointer device with encryption module can be mated with a keyboard to form an integrated device of encrypted keyboard and pointer with software encryption function.

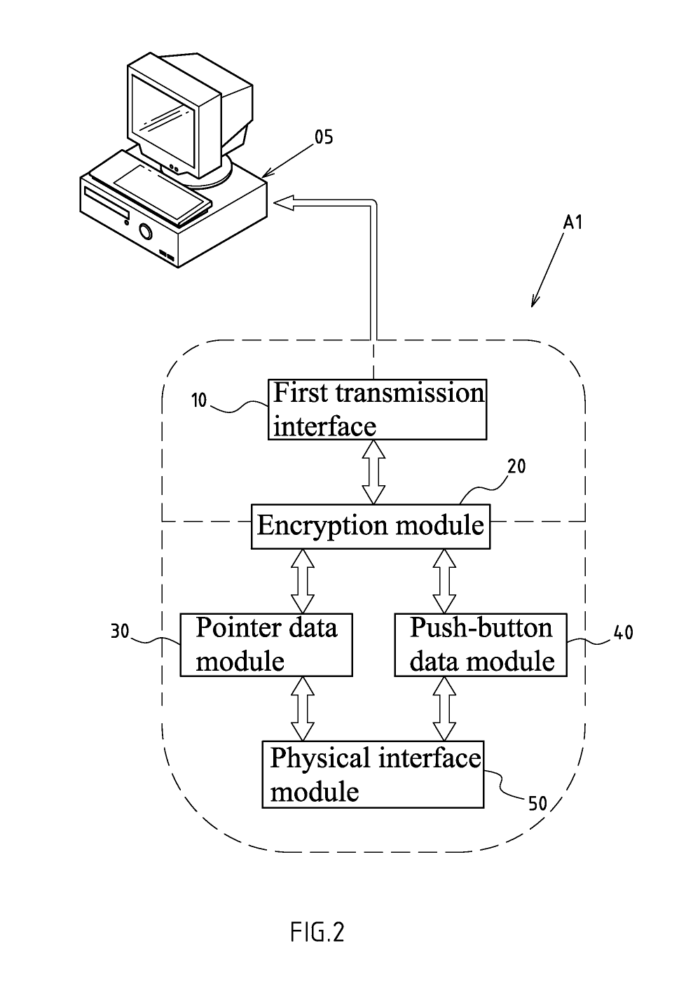

Said device of the present invention can be designed into a pointer device (as shown in FIG. 2, including: a mouse, optical pen, touchpad and touch screen, a mouse pattern shown hereto), comprising: a first transmission interface 10, used to connect the host computer 05; an encryption module 20, used to encrypt and transfer data of the pointer device A1 to the first transmission interface 10; data of said pointer device A1 contains pointer coordinates or the events of left, middle and right keys; a pointer data module 30, used to obtain, convert and save coordinate data of the pointer device A1; a push-button data module 40, used to obtain, convert and save push-button data of the pointer device A1; and a physical interface module 50, used to obtain the coordinates of pointer device A1 and original data of key events.

Thus, the original data obtained by physical interface module 50 shall be converted into the coordinates or push-button data of the pointer device A1 by the pointer data module 30 and push-button data module 40. Then the encryption module 20 decides if it is necessary to transfer the coordinates or push-button data in the form of encryption, thereby preventing logging of the computer on-screen keyboard.

Of which, said pointer device A1 can be mated with a keyboard to form an integrated device of encrypted keyboard and pointer with software encryption functions, as illustrated by another embodiment of said pointer device.

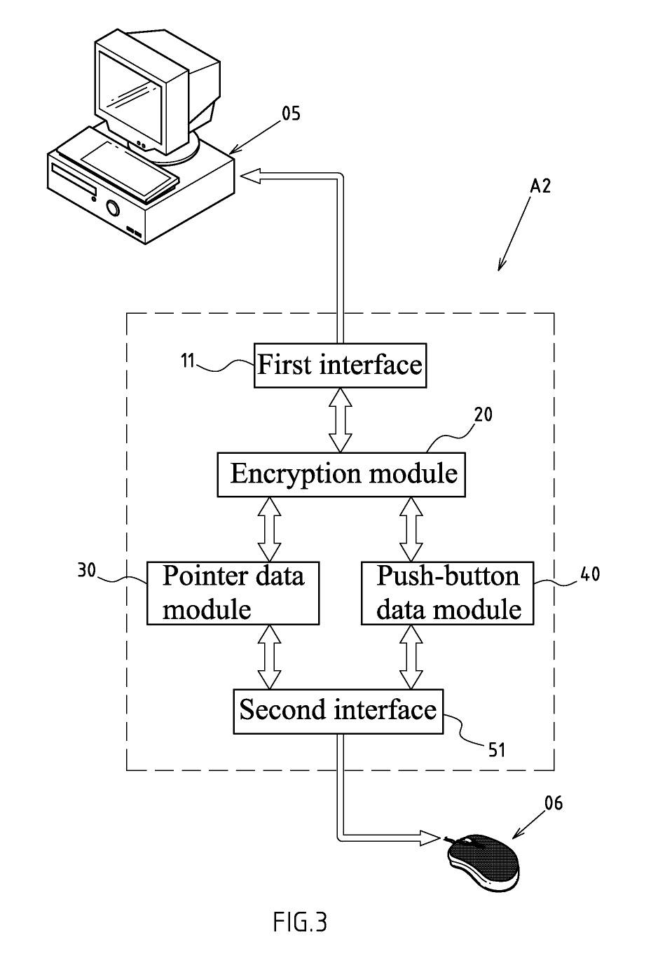

Said device of the present invention can be designed into a tandem device (as shown in FIG. 3). Said tandem device A2 is used to connect the host computer 05 and an existing pointer device 06 for controlling the host computer 05 (note: existing pointer device referred hereto is a conventional one, rather than said pointer device A1 defined, in the present invention).

Said tandem device A2 comprises: a first interface 11, used to connect the host computer 05; an encryption module 20, used to encrypt and transfer data of existing pointer device 06 to the first interface 11; the data of existing pointer device 06 contains the pointer coordinates or the events of left, middle and right keys; a pointer data module 30, used to convert and save the coordinate data of existing pointer device 06; a push-button data module 40, used to convert and save the push-button data of existing pointer device 06: and a second interface 51, used to obtain the coordinates and push-button data of existing pointer device 06.

Thus, the coordinates and push-button data of existing pointer device 06 can be obtained from the second interface 51, then converted into and saved as the coordinates or push-button data of new pointer device by the pointer data module 30 and push-button data module 40. Then, the encryption module 20 decides if it is necessary to transfer the coordinates or push-button data in the form of encryption, thereby preventing logging of the computer on-screen keyboard.

Of which, said first interface 11 and second interface 51 are of wireless or wired plug-in type. Moreover, said pointer device 06 also comprises mouse, optical pen, touchpad and touch screen, etc; existing pointer device 06 in FIG. 3 is shown as a mouse.

1. A method for preventing logging of computer on-screen keyboard; comprising:
an application software set into the computer, enabling to input words via on-screen Keyboard;
a pointer device with an encryption module;
said application software is used to obtain push-button or coordinate data of an encrypted pointer device via encryption module set into the pointer device;
said application software is used to obtain real push-button or coordinate data of the pointer device by means of decryption;
with this design, the on-screen logging software cannot obtain real push-button or coordinate data of the pointer device by means of logging, so the on-screen logging cannot be activated or enabled for logging of on-screen keyboard.

2. The method defined in claim 1, wherein said pointer device comprises: mouse, optical pen, touchpad and touch screen.

3. The method defined in claim 1, wherein said pointer device with encryption module is mated with a keyboard to form an integrated device of encrypted keyboard and pointer with software encryption function.

4. A pointer device for preventing logging of computer on-screen keyboard comprising:
a first transmission interface, used to connect the host computer;
an encryption module, used to encrypt and transfer data of the pointer device to the first transmission interface; the data of the pointer device contains the pointer coordinate or the events of left, middle and right keys;
a pointer data module, used to obtain, convert and save the coordinate data of pointer device;
a push-button data module, used to obtain, convert and save push-button data of pointer device; and
a physical interface module, used to obtain coordinates of pointer device and original data of key events;
thus, the original data obtained by physical interface module shall be converted into the coordinates or push-button data of pointer device by the pointer data module and push-button data module; then the encryption module decides if it is necessary to transfer the coordinate or push-button data in the form of encryption, thereby preventing logging of the computer on-screen keyboard.

5. The device defined in claim 4, wherein said pointer device comprises: mouse, optical pen, touchpad and touch screen.

6. The device defined in claim 4, wherein said pointer device can be mated with a keyboard to form an integrated device of encrypted keyboard and pointer with software encryption function.

7. A tandem device for preventing logging of computer on-screen keyboard, which is used to connect the host computer and an existing pointer device for controlling the host computer; said tandem device comprises:
a first interface, used to connect the host computer;
an encryption module, used to encrypt and transfer data of existing pointer device to the first interface; data of said pointer device contains pointer coordinates or the events of left, middle and right keys;
a pointer data module, used to convert and save the coordinate data of existing pointer device;
a push-button data module, used to convert and save the push-button data of existing pointer device; and
a second interface, used to obtain the coordinates and push-button data of existing pointer device;
thus, the coordinates and push-button data of existing pointer device can be obtained from the second interface, then convened into and saved as the coordinates or push-button data of new pointer device by the pointer data module 30 and push-button data module; then the encryption module decides if it is necessary to transfer the coordinates or push-button data in the form of encryption, thereby preventing logging of the computer on-screen keyboard.

8. The device defined in claim 7, wherein said first and second interfaces are of wireless or wired plug-in type.

9. The device defined in claim 7, wherein said pointer device also comprises:
Mouse, optical pen, touchpad and touch screen.
